(19) United States
(12) Patent Application Publication
(10) Pub. No.: US 2024/0005044 A1
(43) Pub. Date: Jan. 4, 2024

(54) Techniques For Controlling Access To Provisioning Integrated Circuits

(71) Applicant: Intel Corporation, Santa Clara, CA (US)

(72) Inventor: Michael Neve De Mevergnies, Guidel (FR)

(73) Assignee: Intel Corporation, Santa Clara, CA (US)

(21) Appl. No.: 18/369,612

(22) Filed: Sep. 18, 2023

(51) Int. Cl. G06F 21/74; G06F 21/60

(52) U.S. Cl. CPC G06F 21/74; G06F 21/602

(57) ABSTRACT

An integrated circuit includes a cryptographic engine that generates a cryptographic version of a password, a secure storage area, and a security controller circuit that stores an enable bit and at least a portion of the cryptographic version of the password in the secure storage area to enable a security feature. The security controller circuit enables provisioning of the integrated circuit in response to receiving the password from a user if the enable bit stored in the secure storage area indicates that the security feature is enabled.

### TECHNICAL FIELD

The present disclosure relates to electronic integrated circuits, and more particularly, to techniques for controlling access to provisioning integrated circuits.

### BACKGROUND

Configurable integrated circuits can be configured by users to implement desired custom logic functions. In a typical scenario, a logic designer uses computer-aided design (CAD) tools to design a custom circuit design. When the design process is complete, the computer-aided design tools generate configuration data. The configuration data is then loaded into configuration memory elements that configure configurable logic circuits in the integrated circuit to perform the functions of the custom circuit design. Configurable logic integrated circuits can be used for co-processing in big-data or fast-data applications. For example, configurable logic integrated circuits may be used in application acceleration tasks in a datacenter and may be reprogrammed during datacenter operation to perform different tasks.

### BRIEF DESCRIPTION OF DRAWINGS

FIG. 1 is a diagram that shows a configurable integrated circuit (IC) that can be used with techniques disclosed herein.

FIG. 2A is a diagram that illustrates examples of the transfer of information that can occur to enable a security feature for protecting the provisioning flow of an integrated circuit (IC).

FIG. 2B is a diagram that illustrates examples of the transfer of information that can occur to unlock a security feature that protects access to the provisioning flow of an integrated circuit (IC).

FIG. 3 is a diagram of an illustrative configurable integrated circuit (IC) that can be configured according to a user circuit design.

FIG. 4 is a diagram of another illustrative example of a configurable integrated circuit (IC) that can include examples disclosed herein.

FIG. 5 is a diagram of a circuit design system that can be used to design integrated circuits in accordance with an embodiment.

FIG. 6 is a diagram of illustrative computer-aided design (CAD) tools that can be used in a circuit design system in accordance with an embodiment.

### DETAILED DESCRIPTION

Many integrated circuit (IC) devices provide provisioning capabilities. Provisioning an IC device configures the IC device with key material to enable security features such as authentication and confidentiality of the code used to execute the IC device. For example, after provisioning, an IC device can be protected with a digital signature created using a public key encryption security scheme, such that the IC device is under the control of a defined owner in possession of a private key corresponding to a provisioned public key. Once provisioned, a configurable IC device, for example, only accepts configuration data bitstreams that are signed with the private key of the owner and decrypted using the public key. However, this system creates the potential for ransom attacks. Some IC device owners do not want to go through the provisioning process, because the provisioning process involves key management complexities. An adversary with physical access to an IC device could complete the provisioning flow and inject a public key into an un-provisioned device. By design, the device will then become useless to its legitimate owner without the adversary's private key.

Previously known configurable IC devices that have not yet been provisioned as described above have no built-in way to prevent the provisioning flow. An adversary typically requires physical presence to operate the provisioning flow over Joint Test Action Group (JTAG) inputs of the IC device. New provisioning flows and greater platform connectivity to the JTAG network increase the risk to the legitimate owner of the IC device. Although the owner could provision the device, provisioning practically involves complexities that the owner might not welcome and/or be able to handle, such as secure handling of the corresponding private key in an HSM (high security module), the bitstream signature process, and the resale value in case of ownership transfer of the IC device.

According to some examples disclosed herein, password protection gating is provided as a security feature in a provisioning flow of an IC device. The security feature can be enabled to prevent unauthorized access to the provisioning flow of the IC device. A password is selected by a user (e.g., an owner of the IC device). The security feature can, for example, be enabled by storing an enable bit and a hashed and truncated version of the password in secure storage in the IC device (e.g., in fuses). The security feature prevents access to the provisioning flow of the IC device in response to the enable bit being stored in the secure storage. The security feature then requires the password to be provided in order to allow access to the provisioning flow.

The security feature can provide low cost, low effort, and low maintenance protection for the owner of the IC device, while providing a strong assurance against unintentional and malicious provisioning of the IC device. The password size can be established to provide enough resistance against brute-force attacks. A hash of the password is stored in the IC device in order to prevent readback through reverse-engineering or observation techniques. Any password protection techniques can be applied, such as password salting, etc.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs). As discussed herein, an integrated circuit (IC) can include hard logic and/or soft logic. As used herein, “hard logic” generally refers to circuits in an integrated circuit device that are not configurable by an end user. The circuits in an integrated circuit device (e.g., in a configurable logic IC) that are configurable by the end user are referred to as “soft logic.”

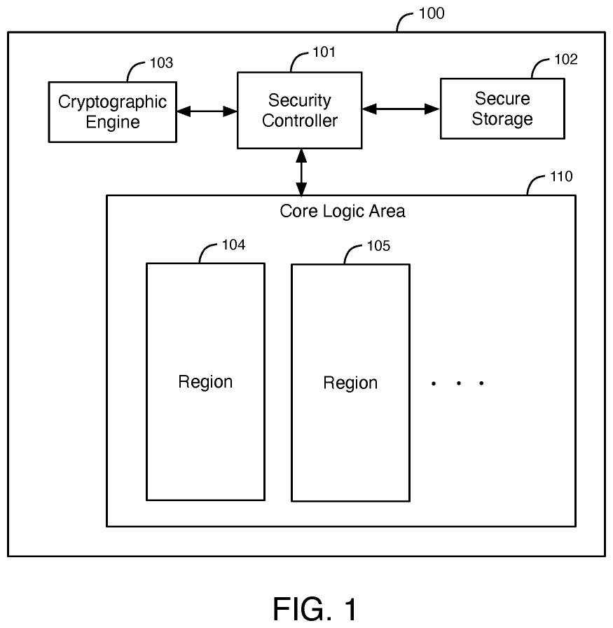

FIG. 1 is a diagram that illustrates a configurable integrated circuit (IC) 100 that can be used with techniques disclosed herein. Configurable IC 100 includes a security controller circuit 101, a secure storage circuit 102 (e.g., a bank of fuses) in a secure storage area of IC 100, a cryptographic engine circuit 103, and a core logic area 110. Core logic area 110 includes multiple regions of configurable logic circuits (soft logic), including regions 104 and 105. Each of the regions 104 and 105 includes several configurable logic circuits. The arrangement of regions 104-105 shown in FIG. 1 is merely an example. In other implementations, the regions of configurable logic circuits can be arranged in any fashion, for example, in an array of rows and columns. The security controller circuit 101 is configured to perform a variety of security functions for the configurable IC 100, including encryption and decryption for configuration data, passwords, etc.

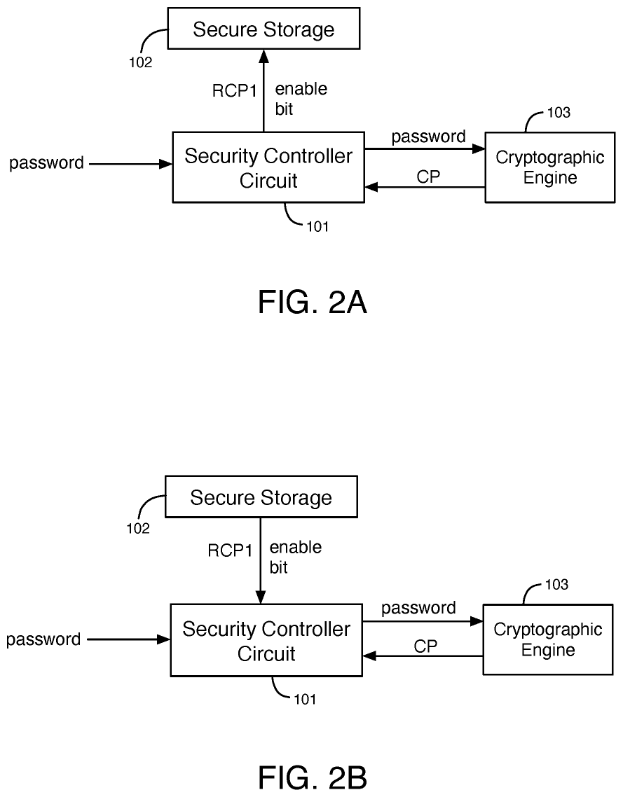

FIG. 2A is a diagram that illustrates examples of the transfer of information that can occur to enable a security feature for protecting the provisioning flow of an integrated circuit (IC). In the example of FIG. 2A, the provisioning flow of IC 100 is augmented with a security feature. As discussed above, a user initially creates a password for the security feature. The password is transmitted to an input of the security controller circuit 101, as shown in FIG. 2A. The security controller circuit 101 then transmits the password to an input of the cryptographic engine circuit 103. The cryptographic engine circuit 103 includes firmware that computes a cryptographic version of the password CP using any suitable cryptographic function, such as a cryptographic hash function. As an example that is not intended to be limiting, the cryptographic engine circuit 103 can compute a hash of the password using the Secure Hash Algorithm SHA-384. The cryptographic engine circuit 103 then transmits the cryptographic version of the password CP to the security controller circuit 101. A cryptographic hash function is mentioned herein merely as an example. According to additional examples, other techniques can also be used to protect the password, such as encryption with a device secret key, etc.

The security controller circuit 101 includes firmware that reduces a size of the cryptographic version of the password CP to generate a reduced sized cryptographic version of the password RCP1. As an example that is not intended to be limiting, the security controller circuit 101 can truncate a hash of the password to generate a truncated hash of the password (i.e., truncated hash). The security controller circuit 101 truncates the hash of the password to a predefined number of digital bits PN to generate the truncated hash. Truncation is merely one example of a technique used to reduce the size. Other techniques can also be used instead of truncation to reduce the size of the cryptographic version of the password.

The security controller circuit 101 then transmits the reduced sized cryptographic version of the password RCP1 and an enable bit to the secure storage circuit 102 as shown in FIG. 2A. The secure storage circuit 102 then stores the enable bit and the reduced sized cryptographic version of the password RCP1 (e.g., in fuses). The security controller circuit 101 enables the security feature by storing the enable bit in the secure storage circuit 102. After the security feature has been enabled, the security controller circuit 101 requires the password to be entered correctly in order to provision the IC 100. Thus, a user must provide the correct password to the security controller circuit 101 in order to provision IC 100 to create an authentication process for protecting access to IC 100, e.g., using a digital signature created with a public key encryption security scheme. The security feature protects the owner of the IC 100 from the financial consequences of unintentional and/or malicious provisioning of the IC that could lock the owner out of using the IC. According to another example, the security feature can also be used to protect an IC device in transit, i.e., from a vendor of the IC device to a buyer of the IC device, in case the vendor is pre-configuring the password in the IC device and communicates the password to the buyer by another means.

FIG. 2B is a diagram that illustrates examples of the transfer of information that can occur to unlock a security feature that protects access to the provisioning flow of an integrated circuit (IC). In the example of FIG. 2B, the security feature has been enabled using the process disclosed herein with respect to FIG. 2A. The security feature protects access to the provisioning flow of IC 100. Prior to authorizing the provisioning flow, firmware in the security controller circuit 101 checks whether the security feature is enabled by accessing the enable bit from the secure storage circuit 102 (e.g., from a corresponding fuse value in secure storage circuit 102). If the enable bit accessed from the secure storage circuit 102 indicates that the security feature is enabled in IC 100, the firmware in the security controller circuit 101 requires that a user provide the correct password in order to begin provisioning IC 100. As an example, the security controller circuit 101 can accept the password as part of a provisioning payload provided to provision IC 100.

After receiving a password input by a user, the security controller circuit 101 transmits the received password to an input of the cryptographic engine circuit 103. The firmware in the cryptographic engine circuit 103 computes a cryptographic version of the received password CP using the same cryptographic function that was used to enable the security feature during the process of FIG. 2A. As an example that is not intended to be limiting, the cryptographic engine circuit 103 can compute a hash of the password using the same cryptographic hash function that was used in the process of FIG. 2A. If a technique other than a cryptographic function was used to protect the password in the process of FIG. 2A, then this same technique is also used to protect the password in the process of FIG. 2B.

The cryptographic engine circuit 103 then transmits the cryptographic version of the received password CP to the security controller circuit 101, as shown in FIG. 2B. The firmware in the security controller circuit 101 then reduces a size of the cryptographic version of the received password CP to generate a reduced sized cryptographic version of the password RCP2 using the same technique that was used to reduce the size of the cryptographic version of the password in the process of FIG. 2A.

As an example, the security controller circuit 101 can truncate a hash of the password to generate a truncated hash of the password. In the process of FIG. 2B, the security controller circuit 101 truncates the hash of the password to the same predefined number of digital bits PN that circuit 101 used to generate the truncated hash in the process of FIG. 2A. Other techniques besides truncation can alternatively be used to reduce the sizes of the cryptographic versions of the passwords in the processes of FIGS. 2A and 2B.

Then, the firmware in the security controller circuit 101 accesses the reduced sized cryptographic version of the password RCP1 from the secure storage circuit 102 (e.g., from fuse values in secure storage circuit 102). The security controller circuit 101 then compares the reduced sized cryptographic version of the password RCP1 accessed from the secure storage 102 to the reduced sized cryptographic version of the password RCP2 generated in the process of FIG. 2B after the security feature has already been enabled. If the security controller circuit 101 determines that RCP1 has the same value as RCP2 (i.e., RCP1=RCP2), then the security controller circuit 101 enables the provisioning flow for IC 100, and thus, the security controller circuit 101 allows the user to provision IC 100. If the security controller circuit 101 determines that RCP1 does not have the same value as RCP2 (i.e., RCP1 #RCP2), then the security controller circuit 101 aborts the provisioning flow for IC 100, prevents the user from provisioning IC 100, and returns an error to the user.

In some implementations, a user that provides the correct password can also elect to disable the security feature. In these implementations, security controller circuit 101 disables the security feature if the user provides the correct password and selects an option to disable the security feature.

In order to increase resistance against brute force attacks to IC 100, the security controller circuit 101 can impose a mandatory power on reset (POR) cycle of IC 100 prior to processing a new request from a user to provision IC 100. Requiring a POR cycle of IC 100 prior to processing a new request for provisioning increases the mean time between trials of the security feature and can result in a reduction of the amount of memory in secure storage 102 (e.g., the fuse count) that is allocated for storing the reduced sized cryptographic version of the password.

For ownership transfer of IC 100, the current owner of IC 100 can provide the password to the new owner of IC 100 as part of the transfer agreement. When the new owner wants to provision the IC 100, the security controller circuit 101 follows the same process disclosed herein with respect to FIG. 2B.

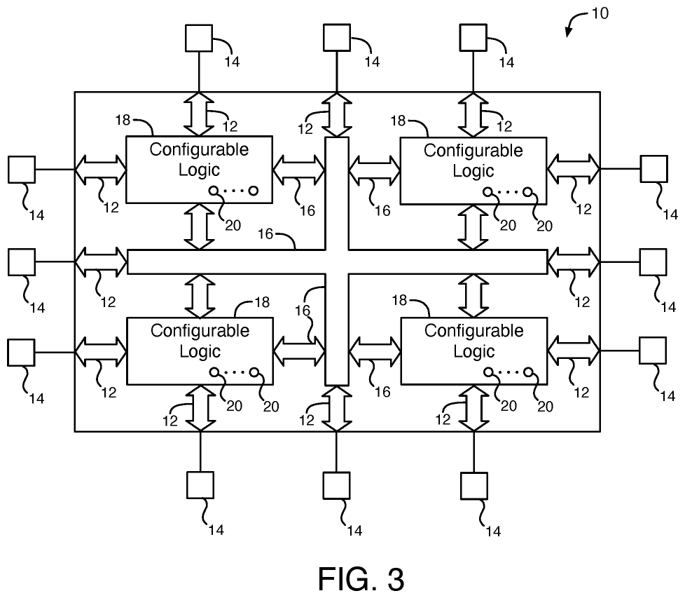

FIG. 3 is a diagram of an illustrative configurable logic integrated circuit (IC) 10 that can be configured according to a user circuit design. Configurable logic IC 10 is an example of an IC as disclosed herein, such as IC 100 of FIG. 1. As shown in FIG. 3, configurable logic integrated circuit 10 can have input-output circuitry 12 for driving signals off of IC 10 and for receiving signals from other devices via input-output pads 14. Interconnection routing resources 16 such as global, regional, and local vertical and horizontal conductive lines and buses may be used to route signals on IC 10. Interconnection resources 16 include fixed interconnects (conductive lines) and programmable interconnects (i.e., programmable connections between respective fixed interconnects). IC 10 includes regions of configurable logic circuitry 18 that can be partial reconfiguration regions. Configurable logic circuitry 18 may include combinational and sequential logic circuitry. Configurable logic circuitry 18 may be configured to perform custom logic functions.

Configurable logic IC 10 contains memory elements 20 that can be loaded with configuration data using pads 14 and input-output circuitry 12. Once loaded, the memory elements 20 may each provide a corresponding static control output signal that controls the state of an associated logic component in configurable logic circuitry 18. Typically, the memory element output signals are used to control the gates of field-effect transistors. In the context of configurable integrated circuits, the memory elements 20 store configuration data and are sometimes referred to as configuration random-access memory (CRAM) cells. The configuration data programs the configurable logic 18 to perform the custom logic functions according to the circuit design.

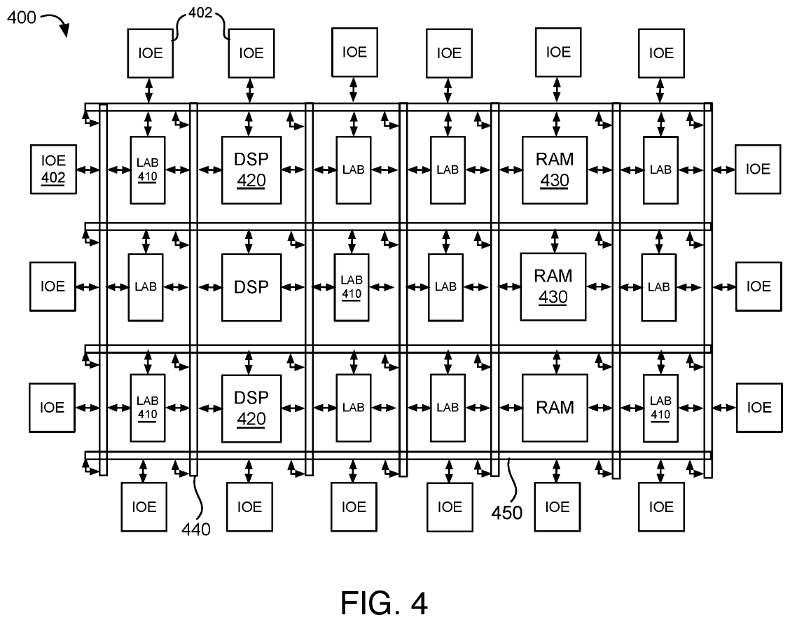

FIG. 4 is a diagram of another illustrative example of a configurable integrated circuit (IC) 400. Configurable IC 400 is an example of an IC as disclosed herein, such as IC 100 of FIG. 1. As shown in FIG. 4, the configurable integrated circuit 400 includes a two-dimensional array of functional blocks, including logic array blocks (LABs) 410 and other functional blocks, such as random access memory (RAM) blocks 430 and digital signal processing (DSP) blocks 420, for example. Functional blocks, such as LABs 410, may include smaller programmable regions (e.g., logic elements, configurable logic blocks, or adaptive logic modules) that receive input signals and perform custom functions on the input signals to produce output signals.

In addition, the configurable integrated circuit 400 may have input/output elements (IOEs) 402 for driving signals off of configurable integrated circuit 400 and for receiving signals from other devices. Input/output elements 402 may include parallel input/output circuitry, serial data transceiver circuitry, differential receiver and transmitter circuitry, or other circuitry used to connect one integrated circuit to another integrated circuit. As shown, input/output elements 402 may be located around the periphery of the IC. If desired, the configurable integrated circuit 400 may have input/output elements 402 arranged in different ways. For example, input/output elements 402 may form one or more columns of input/output elements that may be located anywhere on the configurable integrated circuit 400 (e.g., distributed evenly across the width of the configurable integrated circuit). If desired, input/output elements 402 may form one or more rows of input/output elements (e.g., distributed across the height of the configurable integrated circuit). Alternatively, input/output elements 402 may form islands of input/output elements that may be distributed over the surface of the configurable integrated circuit 400 or clustered in selected areas.

The configurable integrated circuit 400 may also include programmable interconnect circuitry in the form of vertical routing channels 440 (i.e., interconnects formed along a vertical axis of configurable integrated circuit 400) and horizontal routing channels 450 (i.e., interconnects formed along a horizontal axis of configurable integrated circuit 400), each routing channel including at least one track to route at least one wire.

Note that other routing topologies, besides the topology of the interconnect circuitry depicted in FIG. 4, may be used. For example, the routing topology may include wires that travel diagonally or that travel horizontally and vertically along different parts of their extent as well as wires that are perpendicular to the device plane in the case of three dimensional integrated circuits, and the driver of a wire may be located at a different point than one end of a wire. The routing topology may include global wires that span substantially all of configurable integrated circuit 400, fractional global wires such as wires that span part of configurable integrated circuit 400, staggered wires of a particular length, smaller local wires, or any other suitable interconnection resource arrangement.

Furthermore, it should be understood that examples disclosed herein may be implemented in any type of integrated circuit. If desired, the functional blocks of such an integrated circuit may be arranged in more levels or layers in which multiple functional blocks are interconnected to form still larger blocks. Other device arrangements may use functional blocks that are not arranged in rows and columns.

Configurable integrated circuit 400 may contain programmable memory elements. Memory elements may be loaded with configuration data (also called programming data) using input/output elements (IOEs) 402. Once loaded, the memory elements each provide a corresponding static control signal that controls the operation of an associated functional block (e.g., LABs 410, DSP 420, RAM 430, or input/output elements 402).

In a typical scenario, the outputs of the loaded memory elements are applied to the gates of field-effect transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory or programmable memory elements.

The programmable memory elements may be organized in a configuration memory array consisting of rows and columns. A data register that spans across all columns and an address register that spans across all rows may receive configuration data. The configuration data may be shifted onto the data register. When the appropriate address register is asserted, the data register writes the configuration data to the configuration memory elements of the row that was designated by the address register.

Configurable integrated circuit 400 can include configuration memory that is organized in sectors, whereby a sector may include the configuration RAM bits that specify the function and/or interconnections of the subcomponents and wires in or crossing that sector. Each sector may include separate data and address registers.

The configurable IC of FIG. 4 is merely one example of an IC that can be used with embodiments disclosed herein. The embodiments disclosed herein can be used with any suitable electronic integrated circuit or system. For example, the embodiments disclosed herein can be used with numerous types of electronic devices such as processor integrated circuits, central processing units, memory integrated circuits, graphics processing unit integrated circuits, application specific standard products (ASSPs), application specific integrated circuits (ASICs), and configurable logic integrated circuits. Examples of configurable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

It can be a significant undertaking to design and implement a desired (custom) logic circuit design in a configurable logic integrated circuit (IC). Logic designers therefore generally use logic design systems based on computer-aided-design (CAD) tools to assist them in designing circuits. A logic design system can help a logic designer design and test complex circuits for a system. When a design is complete, the logic design system can be used to generate configuration data in a bitstream for electrically programming the appropriate configurable logic IC.

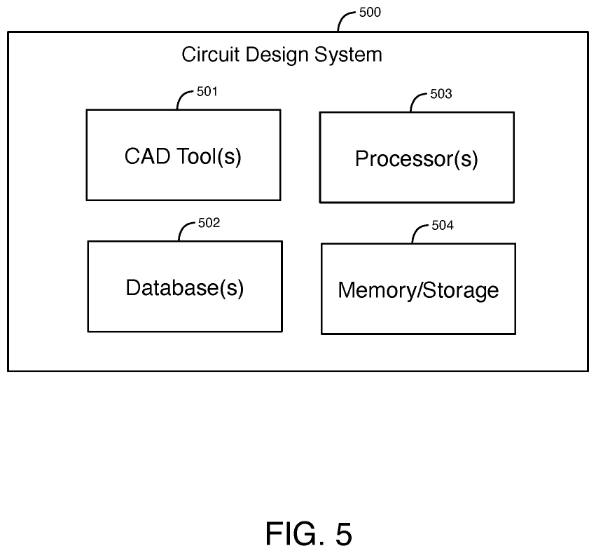

An illustrative circuit design system 500 in accordance with an embodiment is shown in FIG. 5. If desired, the circuit design system of FIG. 5 can be used in a logic design system. Circuit design system 500 can be implemented on integrated circuit design computing equipment. Circuit design system 500 can, for example, include one or more networked computer systems with processors, memory, mass storage, input/output devices, etc. System 500 can, for example, be based on one or more processors 503 such as personal computers, workstations, etc. The processor(s) 503 can be linked using a network (e.g., a local or wide area network). Memory in these computers or external memory and storage devices (collectively shown as memory/storage 504 in FIG. 5) can be used to store instructions and data.

Software-based components such as computer-aided design (CAD) tool(s) 501 and database(s) 502 reside on system 500. During operation, executable software such as the software of computer aided design tool(s) 501 runs on the processor(s) 503 of system 500. Database(s) 502 are used to store data for the operation of system 500. In general, software and data may be stored in non-transitory computer readable storage media (e.g., tangible computer readable storage media), such as memory/storage 504. The software code may sometimes be referred to as software, data, program instructions, instructions, or code. The non-transitory computer readable storage media may include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Software stored on the non-transitory computer readable storage media may be executed on system 500. When the software of system 500 is installed, the storage of system 500 has instructions and data that cause the computing equipment in system 500 to execute various methods (processes). When performing these processes, the computing equipment is configured to implement the functions of circuit design system 500.

The computer aided design (CAD) tool(s) 501, some or all of which are sometimes referred to collectively as a CAD tool, a circuit design tool, or an electronic design automation (EDA) tool, may be provided by a single vendor or by multiple vendors. Tool(s) 501 may be provided as one or more suites of tools (e.g., a compiler suite for performing tasks associated with implementing a circuit design in a programmable IC) and/or as one or more separate software components (tools). Database(s) 502 may include one or more databases that are accessed only by a particular tool or tools and may include one or more shared databases. Shared databases may be accessed by multiple tools. For example, a first tool may store data for a second tool in a shared database. The second tool may access the shared database to retrieve the data stored by the first tool. This allows one tool to pass information to another tool. Tools may also pass information between each other without storing information in a shared database if desired.

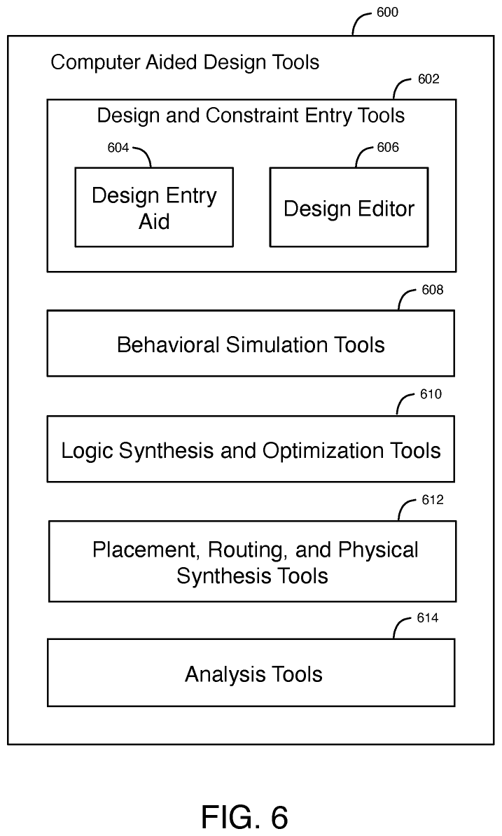

Illustrative computer aided design tools 600 that can be used in a circuit design system such as circuit design system 500 of FIG. 5 are shown in FIG. 6. The design process can start with the formulation of functional specifications of the circuit design (e.g., a functional or behavioral description of the circuit design). A circuit designer can specify the functional operation of a desired circuit design using design and constraint entry tools 602. Design and constraint entry tools 602 can include tools such as design and constraint entry aid 604 and design editor 606. Design and constraint entry aids such as aid 604 can be used to help a circuit designer locate a desired design from a library of existing circuit designs and can provide computer-aided assistance to the circuit designer for entering (specifying) the desired circuit design. Design and constraint entry tools 602 can allow a circuit designer to enter timing constraints for the desired circuit design through aid 604.

As an example, design and constraint entry aid 604 can be used to present screens of options for a user. The user can click on on-screen options to select whether the circuit being designed should have certain features. Design editor 606 can be used to enter a design (e.g., by entering lines of hardware description language code), can be used to edit a design obtained from a library (e.g., using a design and constraint entry aid), or can assist a user in selecting and editing appropriate prepackaged code/designs.

Design and constraint entry tools 602 can be used to allow a circuit designer to provide a desired circuit design using any suitable format. For example, design and constraint entry tools 602 can include tools that allow the circuit designer to enter a circuit design using truth tables. Truth tables can be specified using text files or timing diagrams and can be imported from a library. Truth table circuit design and constraint entry can be used for a portion of a large circuit or for an entire circuit.

As another example, design and constraint entry tools 602 can include a schematic capture tool. A schematic capture tool can allow the circuit designer to visually construct integrated circuit designs from constituent parts such as logic gates and groups of logic gates. Libraries of preexisting integrated circuit designs can be used to allow a desired portion of a design to be imported with the schematic capture tools.

If desired, design and constraint entry tools 602 can allow the circuit designer to provide a circuit design to the circuit design system 500 using a hardware description language such as Verilog hardware description language (Verilog HDL), Very High Speed Integrated Circuit Hardware Description Language (VHDL), SystemVerilog, or a higher-level circuit description language such as OpenCL or SystemC, just to name a few. The designer of the integrated circuit design can enter the circuit design by writing hardware description language code with editor 606. Blocks of code can be imported from user-maintained or commercial libraries if desired.

After the circuit design has been entered using design and constraint entry tools 602, behavioral simulation tools 608 can be used to simulate the functionality of the circuit design. If the functionality of the design is incomplete or incorrect, the circuit designer can make changes to the circuit design using design and constraint entry tools 602. The functional operation of the new circuit design can be verified using behavioral simulation tools 608 before synthesis operations have been performed using tools 610. Simulation tools such as behavioral simulation tools 608 can also be used at other stages in the design flow if desired (e.g., after logic synthesis). The output of the behavioral simulation tools 608 can be provided to the circuit designer in any suitable format (e.g., truth tables, timing diagrams, etc.).

After the functional operation of the circuit design has been determined to be satisfactory, logic synthesis and optimization tools 610 can generate a gate-level netlist of the circuit design, for example, using gates from a particular library pertaining to a targeted process supported by a foundry that has been selected to produce the integrated circuit. Alternatively, logic synthesis and optimization tools 610 can generate a gate-level netlist of the circuit design using gates of a targeted configurable IC (i.e., in the logic and interconnect resources of a particular configurable IC product or product family).

Logic synthesis and optimization tools 610 can optimize the circuit design by making appropriate selections of hardware to implement different logic functions in the circuit design based on the circuit design data and constraint data entered by the logic designer using tools 602. As an example, logic synthesis and optimization tools 610 can perform multi-level logic optimization and technology mapping based on the length of a combinational path between registers in the circuit design and corresponding timing constraints that were entered by the logic designer using tools 602.

After logic synthesis and optimization using tools 610, the circuit design system 500 can use tools such as placement, routing, and physical synthesis tools 612 to perform physical design steps (layout synthesis operations). Tools 612 can be used to determine where to place each gate of the gate-level netlist produced by tools 610. For example, if two counters interact with each other, tools 612 may locate these counters in adjacent regions to reduce interconnect delays or to satisfy timing requirements specifying the maximum permitted interconnect delay. Tools 612 create orderly and efficient implementations of circuit designs for any targeted integrated circuit (e.g., for a given configurable integrated circuit such as a field-programmable gate array (FPGA)).

Tools such as tools 610 and 612 can be part of a compiler suite (e.g., part of a suite of compiler tools provided by a programmable IC vendor). After an implementation of the desired circuit design has been generated using tools 612, the implementation of the design can be analyzed and tested using analysis tools 614. For example, analysis tools 614 can include timing analysis tools, power analysis tools, or formal verification tools, just to name few.

After satisfactory optimization operations have been completed using tools 600 and depending on the targeted integrated circuit technology, tools 600 can produce a mask-level layout description of the integrated circuit or configuration data for programming the configurable logic IC.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Additional examples are now described. Example 1 is an integrated circuit comprising: a cryptographic engine that generates a first cryptographic version of a password; a secure storage area; and a security controller circuit that stores an enable bit and at least a portion of the first cryptographic version of the password in the secure storage area to enable a security feature, wherein the security controller circuit enables provisioning of the integrated circuit in response to receiving the password from a user if the enable bit stored in the secure storage area indicates that the security feature is enabled.

In Example 2, the integrated circuit of Example 1 may optionally include, wherein the cryptographic engine generates a first hash of the password as the first cryptographic version of the password, and wherein the security controller circuit stores the first hash of the password in the secure storage area.

In Example 3, the integrated circuit of Example 2 may optionally include, wherein the cryptographic engine generates a second hash of the password in response to receiving the password from the user, and wherein the security controller circuit compares the first hash of the password accessed from the secure storage area to the second hash of the password to determine whether to allow the provisioning of the integrated circuit.

In Example 4, the integrated circuit of any one of Examples 1-3 may optionally include, wherein the security controller circuit truncates the first cryptographic version of the password to generate a truncated cryptographic version of the password, and wherein the security controller circuit stores the truncated cryptographic version of the password in the secure storage area.

In Example 5, the integrated circuit of any one of Examples 1-4 may optionally include, wherein the security controller circuit prevents the user from provisioning the integrated circuit if the enable bit stored in the secure storage area indicates that the security feature is enabled and if the user fails to provide the password to the security controller circuit.

In Example 6, the integrated circuit of any one of Examples 1-5 may optionally include, wherein the security controller circuit allows access to the integrated circuit to be protected by authentication with a digital signature during the provisioning of the integrated circuit in response to receiving the password from the user.

In Example 7, the integrated circuit of any one of Examples 1-6 may optionally include, wherein the security controller circuit causes access to the integrated circuit to be controlled by a private key and a public key during the provisioning of the integrated circuit in response to receiving the password from the user.

Example 8 is a non-transitory computer readable storage medium comprising computer readable instructions stored thereon for causing an integrated circuit to: generate a first cryptographic version of a first password using a cryptographic function; store at least a first portion of the first cryptographic version of the first password in a secure storage circuit in the integrated circuit; and compare at least the first portion of the first cryptographic version of the first password accessed from the secure storage circuit to at least a second portion of a second cryptographic version of a second password to determine whether to allow the integrated circuit to be provisioned.

In Example 9, the non-transitory computer readable storage medium of Example 8 may optionally include, wherein the computer readable instructions further cause the integrated circuit to store an enable value in the secure storage circuit and to request a user to enter the second password to provision the integrated circuit if the enable value indicates that a security feature has been enabled.

In Example 10, the non-transitory computer readable storage medium of any one of Examples 8-9 may optionally include, wherein the computer readable instructions further cause the integrated circuit to generate a first truncated cryptographic version of the first password and store the first truncated cryptographic version of the first password in the secure storage circuit using a security controller circuit.

In Example 11, the non-transitory computer readable storage medium of Example 10 may optionally include, wherein the computer readable instructions further cause the integrated circuit to generate a second truncated cryptographic version of the second password and compare the first truncated cryptographic version of the first password to the second truncated cryptographic version of the second password to determine whether to allow the integrated circuit to be provisioned.

In Example 12, the non-transitory computer readable storage medium of any one of Examples 8-11 may optionally include, wherein the computer readable instructions further cause the integrated circuit to allow access to the integrated circuit to be protected by authentication during provisioning of the integrated circuit in response to verifying that at least the first portion of the first cryptographic version of the first password matches at least the second portion of the second cryptographic version of the second password received from a user.

In Example 13, the non-transitory computer readable storage medium of any one of Examples 8-12 may optionally include, wherein the computer readable instructions further cause the integrated circuit to generate a first hash of the first password, store a first part of the first hash of the first password in the secure storage circuit, and compare the first part of the first hash of the first password accessed from the secure storage circuit to a second part of a second hash of the second password received from a user to determine whether to allow the integrated circuit to be provisioned.

Example 14 is a method for protecting access to an integrated circuit, the method comprising: generating a first cryptographic version of a first password using a cryptographic function in the integrated circuit; storing at least a first portion of the first cryptographic version of the first password in a secure storage circuit in the integrated circuit; and comparing at least the first portion of the first cryptographic version of the first password received from the secure storage circuit to at least a second portion of a second cryptographic version of a second password received from a user to determine whether to permit the integrated circuit to be provisioned.

In Example 15, the method of Example 14 further comprises: storing an enable bit in the secure storage circuit to enable a security feature that protects provisioning of the integrated circuit.

In Example 16, the method of Example 15 further comprises: accessing the enable bit from the secure storage circuit to determine whether the security feature is enabled; and requesting the second password from the user if the security feature is enabled before permitting the integrated circuit to be provisioned.

In Example 17, the method of any one of Examples 14-16 further comprises: generating a first truncated cryptographic version of the first password that is stored in the secure storage circuit; and generating a second truncated cryptographic version of the second password received from the user, wherein the comparing further comprises comparing the first truncated cryptographic version of the first password to the second truncated cryptographic version of the second password to determine whether to permit the integrated circuit to be provisioned.

In Example 18, the method of any one of Examples 14-17 further comprises: generating the second cryptographic version of the second password using the cryptographic function in response to receiving the second password from the user.

In Example 19, the method of any one of Examples 14-18 further comprises: causing access to the integrated circuit to be protected by authentication during provisioning of the integrated circuit if the first portion of the first cryptographic version of the first password matches the second portion of the second cryptographic version of the second password.

In Example 20, the method of any one of Examples 14-19 further comprises: causing access to the integrated circuit to be controlled by a private key and a public key during provisioning of the integrated circuit if the first portion of the first cryptographic version of the first password matches the second portion of the second cryptographic version of the second password.

In Example 21, the method of any one of Examples 14-20, wherein the integrated circuit is a configurable logic integrated circuit.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

1. An integrated circuit comprising:
a cryptographic engine that generates a first cryptographic version of a password;
a secure storage area; and
a security controller circuit that stores an enable bit and at least a portion of the first cryptographic version of the password in the secure storage area to enable a security feature, wherein the security controller circuit enables provisioning of the integrated circuit in response to receiving the password from a user if the enable bit stored in the secure storage area indicates that the security feature is enabled.

2. The integrated circuit of claim 1, wherein the cryptographic engine generates a first hash of the password as the first cryptographic version of the password, and wherein the security controller circuit stores the first hash of the password in the secure storage area.

3. The integrated circuit of claim 2, wherein the cryptographic engine generates a second hash of the password in response to receiving the password from the user, and wherein the security controller circuit compares the first hash of the password accessed from the secure storage area to the second hash of the password to determine whether to allow the provisioning of the integrated circuit.

4. The integrated circuit of claim 1, wherein the security controller circuit truncates the first cryptographic version of the password to generate a truncated cryptographic version of the password, and wherein the security controller circuit stores the truncated cryptographic version of the password in the secure storage area.

5. The integrated circuit of claim 1, wherein the security controller circuit prevents the user from the provisioning of the integrated circuit if the enable bit stored in the secure storage area indicates that the security feature is enabled and if the user fails to provide the password to the security controller circuit.

6. The integrated circuit of claim 1, wherein the security controller circuit allows access to the integrated circuit to be protected by authentication with a digital signature during the provisioning of the integrated circuit in response to receiving the password from the user.

7. The integrated circuit of claim 1, wherein the security controller circuit causes access to the integrated circuit to be controlled by a private key and a public key during the provisioning of the integrated circuit in response to receiving the password from the user.

8. A non-transitory computer readable storage medium comprising computer readable instructions stored thereon for causing an integrated circuit to:
generate a first cryptographic version of a first password using a cryptographic function;
store at least a first portion of the first cryptographic version of the first password in a secure storage circuit in the integrated circuit; and
compare at least the first portion of the first cryptographic version of the first password accessed from the secure storage circuit to at least a second portion of a second cryptographic version of a second password to determine whether to allow the integrated circuit to be provisioned.

9. The non-transitory computer readable storage medium of claim 8, wherein the computer readable instructions further cause the integrated circuit to store an enable value in the secure storage circuit and to request a user to enter the second password to provision the integrated circuit if the enable value indicates that a security feature has been enabled.

10. The non-transitory computer readable storage medium of claim 8, wherein the computer readable instructions further cause the integrated circuit to generate a first truncated cryptographic version of the first password and store the first truncated cryptographic version of the first password in the secure storage circuit using a security controller circuit.

11. The non-transitory computer readable storage medium of claim 10, wherein the computer readable instructions further cause the integrated circuit to generate a second truncated cryptographic version of the second password and compare the first truncated cryptographic version of the first password to the second truncated cryptographic version of the second password to determine whether to allow the integrated circuit to be provisioned.

12. The non-transitory computer readable storage medium of claim 8, wherein the computer readable instructions further cause the integrated circuit to allow access to the integrated circuit to be protected by authentication during provisioning of the integrated circuit in response to verifying that at least the first portion of the first cryptographic version of the first password matches at least the second portion of the second cryptographic version of the second password received from a user.

13. The non-transitory computer readable storage medium of claim 8, wherein the computer readable instructions further cause the integrated circuit to generate a first hash of the first password, store a first part of the first hash of the first password in the secure storage circuit, and compare the first part of the first hash of the first password accessed from the secure storage circuit to a second part of a second hash of the second password received from a user to determine whether to allow the integrated circuit to be provisioned.

14. A method for protecting access to an integrated circuit, the method comprising:
generating a first cryptographic version of a first password using a cryptographic function in the integrated circuit;
storing at least a first portion of the first cryptographic version of the first password in a secure storage circuit in the integrated circuit; and
comparing at least the first portion of the first cryptographic version of the first password received from the secure storage circuit to at least a second portion of a second cryptographic version of a second password received from a user to determine whether to permit the integrated circuit to be provisioned.

15. The method of claim 14 further comprising:
storing an enable bit in the secure storage circuit to enable a security feature that protects provisioning of the integrated circuit.

16. The method of claim 15 further comprising:
accessing the enable bit from the secure storage circuit to determine whether the security feature is enabled; and
requesting the second password from the user if the security feature is enabled before permitting the integrated circuit to be provisioned.

17. The method of claim 14 further comprising:
generating a first truncated cryptographic version of the first password that is stored in the secure storage circuit; and
generating a second truncated cryptographic version of the second password received from the user, wherein the comparing further comprises comparing the first truncated cryptographic version of the first password to the second truncated cryptographic version of the second password to determine whether to permit the integrated circuit to be provisioned.

18. The method of claim 14 further comprising:
generating the second cryptographic version of the second password using the cryptographic function in response to receiving the second password from the user.

19. The method of claim 14 further comprising:
causing access to the integrated circuit to be protected by authentication during provisioning of the integrated circuit if the first portion of the first cryptographic version of the first password matches the second portion of the second cryptographic version of the second password.

20. The method of claim 14 further comprising:
causing access to the integrated circuit to be controlled by a private key and a public key during provisioning of the integrated circuit if the first portion of the first cryptographic version of the first password matches the second portion of the second cryptographic version of the second password.
